(19) United States
(12) Patent Application Publication
(10) Pub. No.: US 2008/0145040 A1
(43) Pub. Date: Jun. 19, 2008

(54) SIMULTANEOUS IMAGING OF MULTIPLE SPECIMEN SLIDES ON A SINGLE SLIDE STAGE

(75) Inventor: Barry Hunt, Andover, MA (US)

Correspondence Address: VISTA IP LAW GROUP LLP, 12930 Saratoga Avenue, Suite D-2, Saratoga, CA, 95070, US

(73) Assignee: CYTYC CORPORATION, Marlborough, MA (US)

(21) Appl. No.: 11/613,173

(22) Filed: Dec. 19, 2006

(51) Int. Cl. G03B 15/00

(52) U.S. Cl. 396/5

(57) ABSTRACT

System for simultaneously imaging multiple biological specimens on a single, translatable stage of an imaging system. The stage supports multiple specimen carriers, such as slides, which carry biological specimens. When the stage is at a first location, a first image acquisition component takes an image of a first portion of a first specimen, and a second image acquisition component takes an image of a first portion of second specimen. The stage is moved from the first location to a second location, thereby moving the slides and specimens carried thereby in the same direction and by the same amount. At the second location, the first acquisition component takes an image of a second portion of the first specimen, and the second acquisition component acquires an image of a second portion of a second specimen. Lenses of acquisition components are independently adjustable for independent focusing by acquisition components.

### FIELD OF INVENTION

The present invention relates to the preparing and analysis of biological specimen slides and, more particularly, to obtaining images of multiple specimen slides at the same time.

### BACKGROUND

Medical professionals and technicians often analyze biological specimen slides thereon in order to analyze whether a patient has or may have a particular medical condition or disease. For example, a cytological specimen slide may be prepared and examined for the presence of malignant or pre-malignant cells as part of a Papanicolaou (Pap) smear test, or other cancer detection tests. To facilitate this review process, images of the specimen are acquired, and automated systems focus the technician's attention on the most pertinent cells or groups of cells in selected images, while discarding less relevant cells from further review. One such imaging system that is commercially available is the Thinprep Imaging System, available from Cytyc Corporation, 250 Campus Drive, Marlborough, Mass. 01752 (www.cytyc.com).

FIG. 1 generally illustrates an exemplary imaging system 10 that includes a controller 11, an optical stack 12 and a robot 13 for feeding and removing specimen slides 14 to and from the optical stack 12. Images 15 generated by the optical stack 12 are provided to the computer 11 for analysis. Referring to FIG. 2, the optical stack 12 includes a motion control board computer or controller 20, a stage 21, a light source 22, a lens 23 and a camera 24. Referring to FIG. 3, the robot 13 takes a slide 14 from a cassette 30 and places the slide 14 on the stage 21. The computer 11 controls the MCB computer 20 so that the computer 20 moves the stage 21 to locate the slide 14 under the camera 24 and lens 23. The light source 22 is activated, and an image 15 of a portion of the specimen on the slide 14 is acquired by the camera 24 and provided to the computer 11. The computer 11 instructs the computer 20 to move the stage 21 and the slide 14 thereon a very short distance from a first location to a second location. An image 15 of the next portion of the specimen on the slide 14 at the second location is acquired by the camera 24 and provided to the computer 11.

More specifically, referring to FIG. 4, the stage 21 is moved to a different location after an image is taken of different portions 41-45 of the specimen 40 on the slide 14. A first portion 41 of the specimen 40 is imaged when the stage 21 is at a first stage location (location 1). The stage 21 is moved to a second location (location 2), and an image of a second portion 42 of the specimen is acquired at the second location. The stage 21 is moved to a third location (location 3), and an image of the third portion 43 of the specimen 40 is acquired, and so on for each portion of the specimen until the entire specimen is imaged. In known imaging systems, the stage 21 can be moved about 2,400 times to acquire 2,400 images of 2,400 different portions of a specimen 40. The robot 13 then removes the imaged slide 14 from the stage 21 and places another slide 14 from the cassette 30 onto the stage 21 for imaging as described above.

Notably, the amount of time that is required to digitize a specimen slide is largely a function of how many times the stage and slide thereon must be moved and how many images are acquired. More particularly, substantial time is spent moving the stage and allowing the stage to settle after each movement. As a result, several minutes may be required to image a single specimen slide. One way to reduce imaging times is to take fewer images of the specimen, which would involve fewer movements of the stage. However, this approach also involves reducing the magnification in order to capture a larger portion of the specimen per image, and many image analysis systems impose limitations on the minimum acceptable resolution which, in turn, imposes minimum magnification requirements. Thus, this may not be a desirable option.

Another way to reduce imaging time is to use a camera that can take larger images, which would also require fewer stage movements. However, most cameras are available up to a finite size, and as camera size increases, so do camera costs. Further, many imaging systems rely on sharply focused images across the entire image. An image that spans a much larger portion of a slide increases the likelihood that some portion of the image will be out of focus and, therefore, unusable.

Another approach to reduce imaging time is to use two imagers. While this may double imaging throughput, the time that is required to image a particular specimen would remain the same, and this is not a cost effective option, since using a second imaging doubles imaging and maintenance costs and also requires twice the amount of laboratory space.

Accordingly, there exists a need for a system and method that can image multiple slides at the same time using a single imager so that imaging can be completed more quickly than known imaging systems. The system and method should preferably be able to image multiple specimen slides on a single stage without increasing the number of times a stage must be moved.

### SUMMARY

In one embodiment, a system for simultaneous imaging of multiple biological specimens includes a translatable stage and multiple image acquisition components. The stage supports a first specimen carrier having a first biological specimen and a second specimen carrier having a second biological specimen. The stage and the first and second image acquisition components are arranged so that images of the first and second biological specimens on the stage can be simultaneously taken by respective first and second image acquisition components.

In an alternative embodiment, a system for simultaneously imaging multiple biological specimens includes a translatable stage, multiple image acquisition components and a controller. The translatable stage supports a first specimen carrier having a first biological specimen and a second specimen carrier having a second biological specimen. The controller moves the translatable stage and controls the first and second image acquisition components. The translatable stage and the first and second image acquisition components are arranged and controlled so that an image of a first portion of the first biological specimen and a an image of a first portion of the second biological specimen can be simultaneously taken by respective first and second image acquisition components when the translatable stage is at a first location. Additionally, an image of a second portion of the first biological specimen and an image of a second portion of the second biological specimen can be simultaneously taken by respective first and second image acquisition components when the translatable stage is at a second location.

Another alternative embodiment is directed to a method of simultaneously imaging multiple biological specimens on different specimen carriers. The method includes placing a first specimen carrier having a first biological specimen and a second specimen carrier having a second biological specimen on a single, translatable stage. The method further includes simultaneously acquiring images of the first biological specimen with a first image acquisition component and the second biological specimen with a second image acquisition component when the translatable stage is at a first location.

In a further alternative embodiment, a method of imaging multiple biological specimens on different specimen carriers at the same time includes placing a first specimen carrier having a first biological specimen and a second specimen carrier having a second biological specimen on a translatable stage and simultaneously acquiring images of a first portion of the first biological specimen with a first image acquisition component and a first portion of the second biological specimen with a second image acquisition component when the translatable stage is at a first location. The translatable stage is moved from first location to a second location, and then images of a second portion of the first biological specimen are acquired with the first image acquisition component at the same time that images of a second portion of the second biological specimen are acquired with the second image acquisition component when the translatable stage is at the second location.

In various embodiments, the first and second biological specimens are positioned so that a first portion of the first biological specimen that is imaged corresponds to the first portion of the second biological specimen that is imaged. Further, with the first and second specimen carriers being supported by the same stage, the specimen carriers can be moved at the same time, by the same amount and in the same direction as the translatable stage when the stage is moved. Lenses of different image acquisition components can be independently adjustable so that a lens of one first image acquisition component is adjusted at the same time as and independently of a lens of a second acquisition component, thereby allowing the first optical acquisition component to focus on the first specimen while the second optical acquisition component focuses on the second specimen. The translatable stage can support additional biological specimens so that two or more specimens on the same translatable stage can be imaged at the same time.

Other aspects of embodiments are described herein and will become apparent upon reading the following detailed description with reference to the accompanying drawings.

### BRIEF DESCRIPTION OF THE DRAWINGS

Referring now to the drawings in which like reference numbers represent corresponding parts throughout and in which:

FIG. 1 generally illustrates a known imaging system;

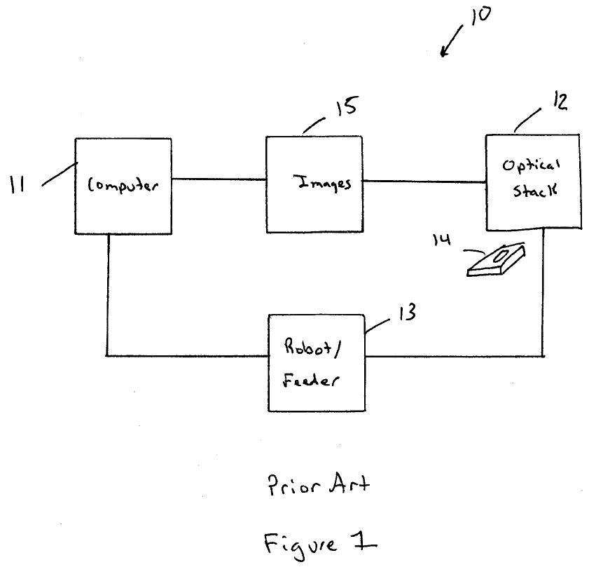

FIG. 2 generally illustrates components of an optical stack of a known imaging system;

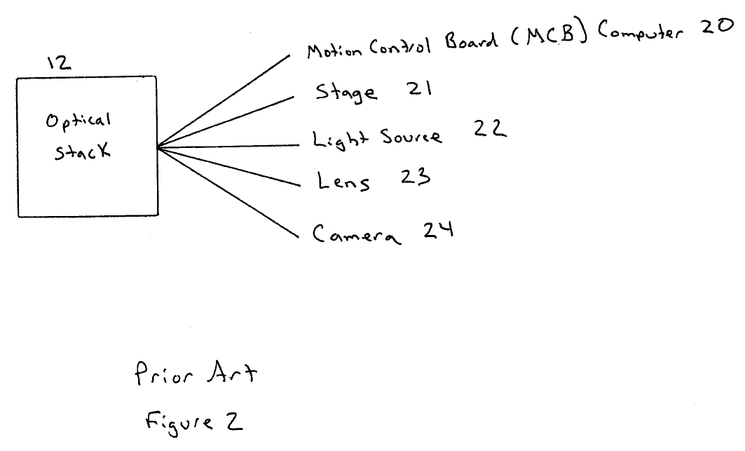

FIG. 3 further illustrates a known imaging system for imaging one specimen slide on a stage at a time;

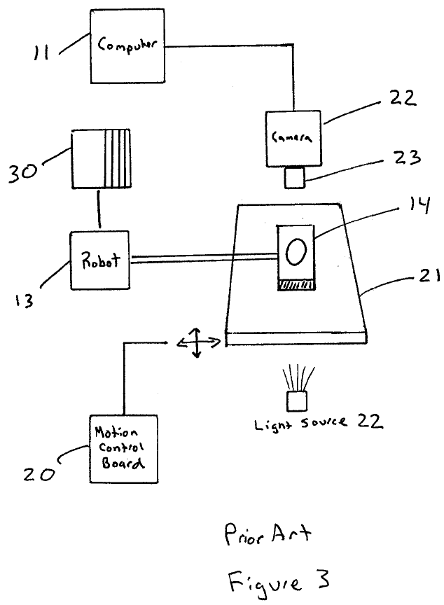

FIG. 4 illustrates how portions of a biological specimen are imaged;

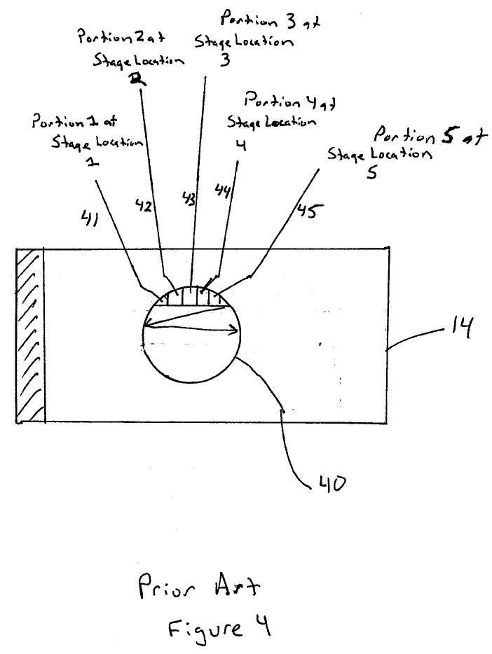

FIG. 5 illustrates a system for imaging multiple slides on a single stage at the same time according to one embodiment;

FIG. 6 illustrates multiple slides that can be imaged on a single stage at the same time according to an alternative embodiment;

FIG. 7 is a flow chart illustrating a method of imaging multiple specimen slides on a single stage at the same time according to one embodiment;

FIG. 8 illustrates portions of different specimen slides arranged side-by-side on a single stage being imaged at the same time according to one embodiment;

FIG. 9 illustrates portions of different specimen slides arranged vertically on a single stage being imaged at the same time according to one embodiment;

FIG. 10 illustrates an imaging system having multiple lenses that are independently adjustable to focus portions of different specimens on a single stage according to one embodiment;

FIG. 11 is a flow chart illustrating a method of simultaneously imaging multiple specimen slides on a single stage using the system shown in FIG. 10 according to another embodiment;

FIG. 12 illustrates a known raster pattern for imaging a biological specimen;

FIG. 13 illustrates cytological specimens that are slightly offset;

FIG. 14 is a flow chart illustrating a method of determining a raster pattern for imaging different specimen slides on a single stage at the same time according to another embodiment;

FIG. 15 illustrates a raster pattern in the form of an enlarged circle for use with various embodiments; and

FIG. 16 illustrates a raster pattern in the form of an extended circle for use in various embodiments.

### DETAILED DESCRIPTION OF THE ILLUSTRATED EMBODIMENTS

In the following description, reference is made to the accompanying drawings which form a part hereof, and which show by way of illustration specific embodiments and how they may be practiced. In particular, embodiments of the invention improve upon known slide imaging systems by providing systems and methods that advantageously enable multiple biological specimen slides on a single stage of the same imaging system to be imaged at the same time. Thus, embodiments of the invention can substantially reduce the time that is required to image a slide compared to known imaging systems that image only one slide at a time. Such embodiments may be implemented by integrating and synchronizing additional selected optical components so that multiple specimen slides on a single stage can be imaged simultaneously without the need for a separate second imaging system.

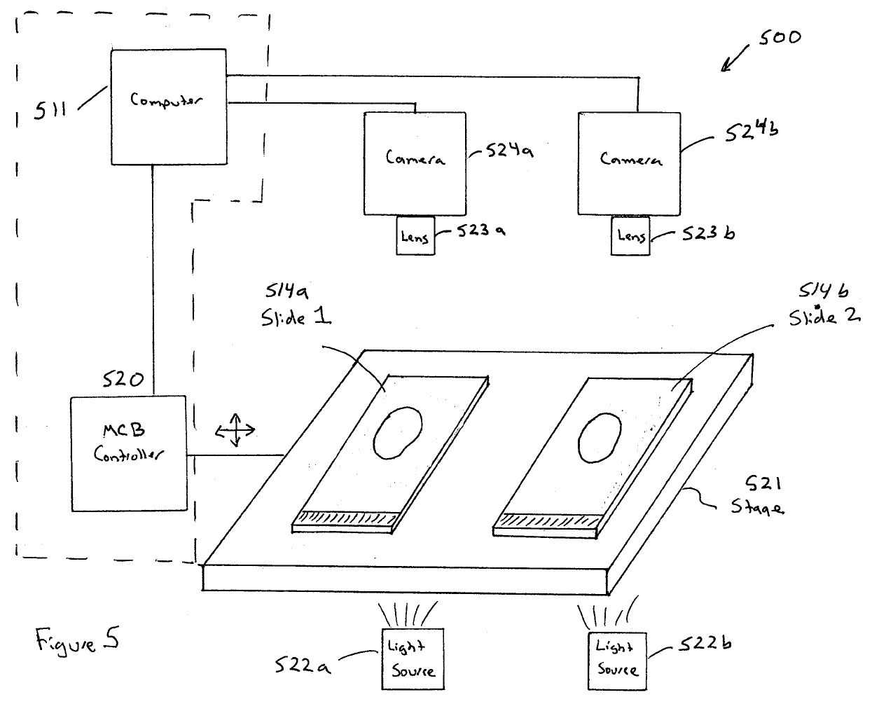

Referring to FIG. 5, an imaging system 500 according to one embodiment includes a computer 511, first and second cameras 524a and 524b (generally camera 524), first and second lenses 523a and 523b (generally lens 523) for respective cameras 524, a translatable stage 521 for holding multiple specimen carriers, e.g., multiple slides 514a and 514b (generally slide 514), first and second light sources 522a and 522b (generally 522), and a MCB controller 520 for controlling movement of the stage 521. A camera 524 and a lens 523 are positioned above each slide 514, and a light source 522 is positioned below the stage 521 to provide light and allow images of the specimen to be acquired by the camera 524.

FIG. 5 illustrates a separate computer 511 and MCB controller 520, and the computer 511 providing instructions to the MCB controller 520 to control movement of the stage 521. Person skilled in the art, however, will appreciate that a single computer or controller (as shown by dotted lines) can be used rather than separate computer 511 and controller 520 components. Further, persons skilled in the art will appreciate that different numbers of computers or controllers can function independently or together. Accordingly, FIG. 5 illustrating a separate computer 511 and controller 520 is provided for purposes of explanation and illustration.

Additionally, separate light sources 522a and 522b can be combined into a single light source 522 that provides light to multiple cameras 524. For example, the single light source 522 can extend across the width of the stage 521 so that light is provided to multiple cameras 524. For purposes of explanation and illustration, this specification refers to imaging each individual slide using separate camera, lens and light source components. Thus, with reference to FIG. 5, a specimen slide 514a on the stage 521 is imaged using a camera 524a, a lens 523a and a light source 522a, and a specimen slide 514b on the same stage 521 is imaged using a camera 524b, a lens 523b and a light source 522b.

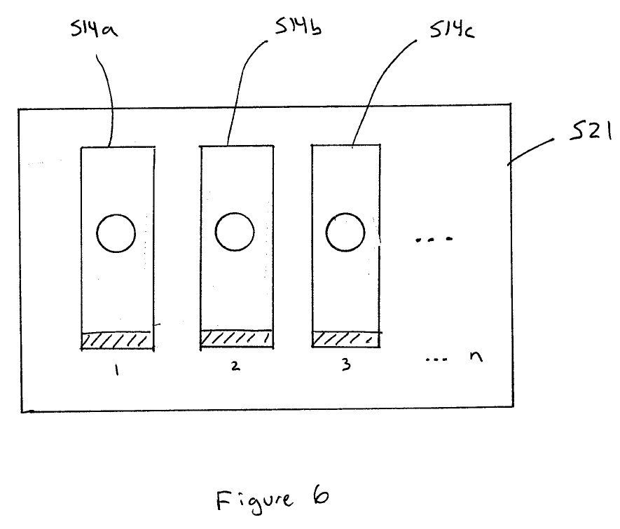

In the illustrated embodiment, the stage 521 carriers two slides 514a and 514b. In alternative embodiments, the stage 521 can carry other numbers of slides 514. For example, FIG. 6 illustrates three or more slides 514a-c supported by the stage 521. The height, width, material and/or weight of the stage 521 can be selected as necessary to accommodate simultaneous imaging of additional slides 514 while maintaining acceptable stage 521 movement and settle times. For example, a stage 521 carrying two slides 514 can have a width of about 5.5″ to about 6.0″ and can have a greater width to accommodate additional slides 514.

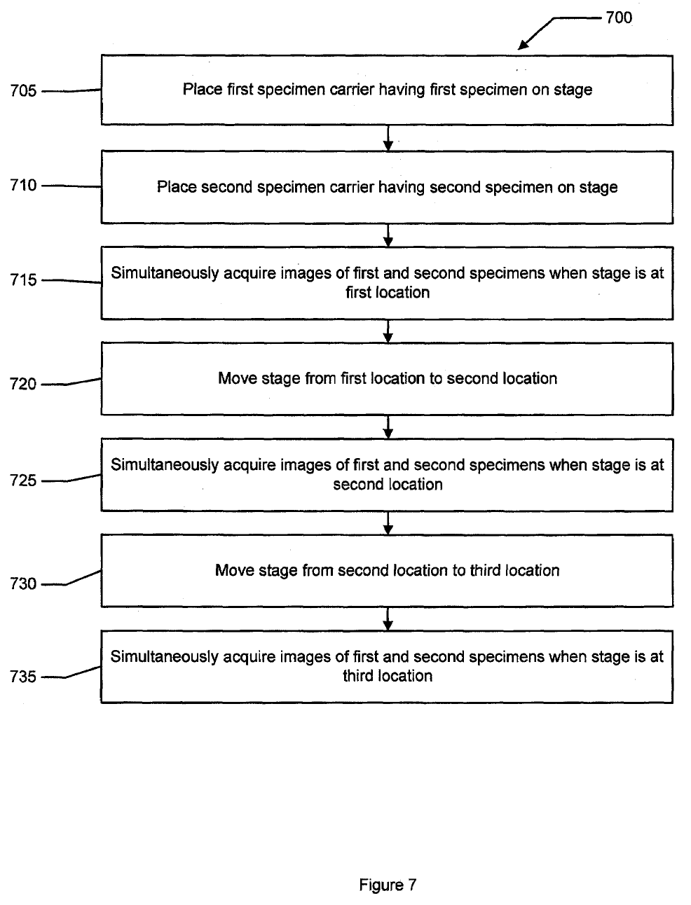

Referring to FIG. 7, a method 700 of imaging multiple specimen slides at the same time according to one embodiment using, for example, the system shown in FIG. 5, includes placing a first specimen carrier or slide on the stage in step 705. In step 710, a second specimen carrier or slide is placed on the same stage. Persons skilled in the art will appreciate that these steps can be performed in different orders or at the same time. In step 715, images of the first and second specimens are acquired at the same time when the stage is at a first location. In step 720, after the images at the first stage location are acquired, the stage is moved from the first location to a second location. The stage can be triggered to move to the next location based on various criteria, such as a pre-determined time following the acquisition of the last image or a pre-determined time following the last focus adjustment. The distance that the stage is moved can vary depending on, for example, the size of the camera's acquisition.

In step 725, after the stage is moved and settles at the second location, images of the first and second specimens are acquired at the same time while the stage is at the second location. In step 730, after the images are acquired at the second location, the stage is moved from the second location to the third location. After the stage settles at the third location, in step 735, images of the first and second specimens are acquired at the same time while the stage is at the third location. The steps of moving the stage, allowing the stage to settle, and acquiring images of multiple specimens at the same time at a given stage location is repeated until an image of the entire first specimen and an image of the entire second specimen are acquired.

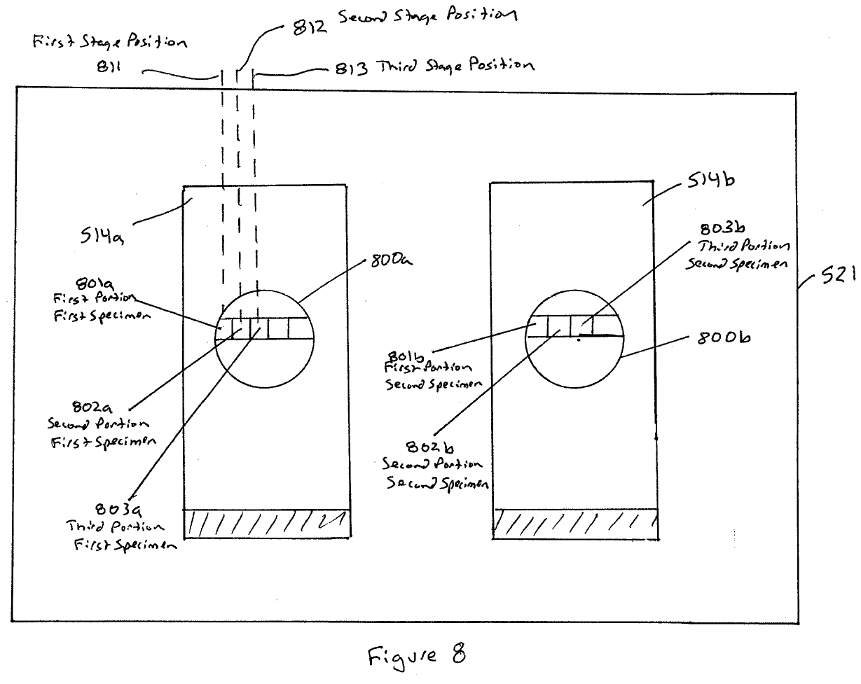

The slides 514 move with the stage 521 as the stage moves. More specifically, the slides 514 move at the same time, in the same direction, and by the same amount as the stage 521. Thus, the specimens on the slides 514 also move at the same time, in the same direction, and by the same amount as the stage 521. For example, as shown in FIG. 8, a first slide 514a having a first specimen 800a and a second slide 514b having a second specimen 800b are arranged side-by-side on the stage 521. A first portion 801a of the first specimen 800a and a first portion 801b of the second specimen 800b are imaged at the same time when the stage 521 is at a first location (indicated by reference number 811). Similarly, a second portion 802a of the first specimen 800a and a second portion 802b of the second specimen 800b are imaged at the same time when the stage 521 is at a second location (indicated by reference number 812), and a third portion 803a of the first specimen 800a and a third portion 803b of the second specimen 800b are imaged at the same time when the stage 521 is at a third location (indicated by reference number 813). The process of imaging multiple portions of different specimens 800 on the same stage 521 at the same time can be repeated until the entire first specimen 800a and the entire second specimen 800b are imaged. A robot can then remove the first and second specimen slides 514a and 514b and place new specimen slides on the stage 521 for imaging.

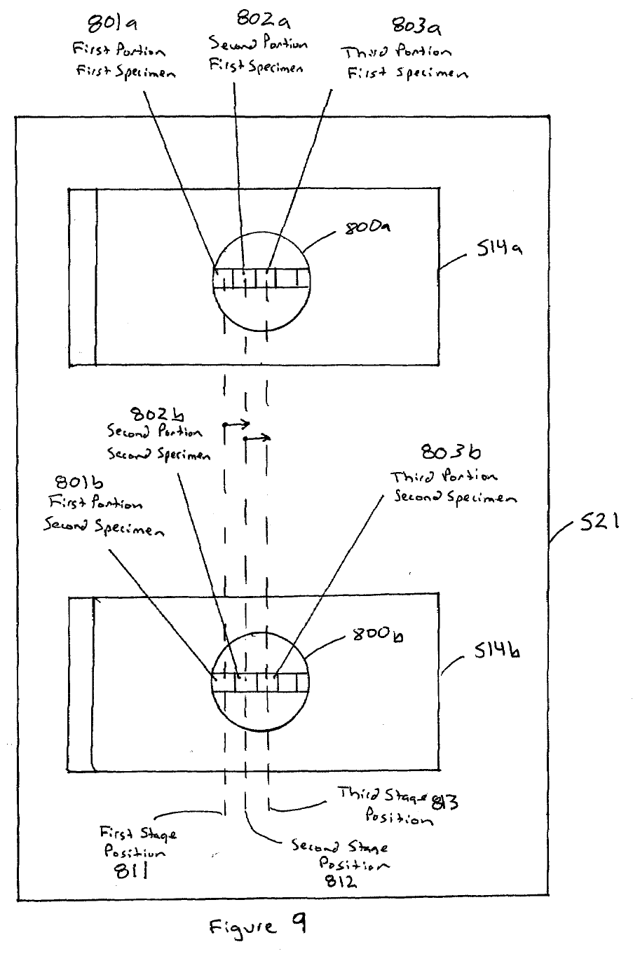

In the embodiments illustrated in FIGS. 5, 6 and 8, multiple specimen slides 514 are arranged side-by-side on the same stage 521. In an alternative embodiment, as shown in FIG. 9, multiple specimen slides 514 can be positioned one above the other on the same stage 521 and imaged simultaneously.

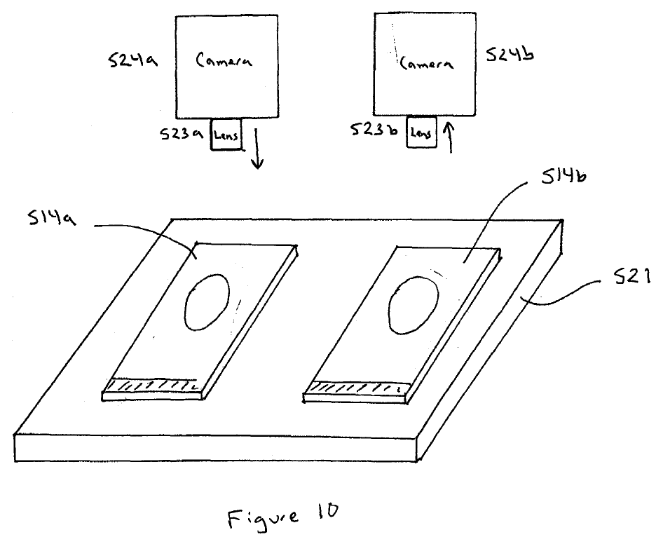

Referring to FIG. 10, in order to focus on portions of different specimens on difference slides 514, according to on embodiment, each lens 523 is adjustable independently (shown by arrows) of the other lenses 523 of the imaging system 500. This allows different portions of each specimen to be properly focused.

For this purpose, additional focus controls can be implemented with various MCB controllers 520. For example, one suitable MCB controller 520 for an imaging system 500 that images two slides 514 on a single stage 521 at the same time is a four axis MCB controller 520. A four axis MCB controller includes adjustments for the “x” location of the stage 521, the “y” location of the stage 521, a first focus control for the first lens 523a, and a second focus control for the second lens 523b. If additional slides 514 are to be imaged, then an additional focus controls can be utilized, e.g. with a six or eight axis MCB controller 520.

There can be instances in which the first and second lenses 523a and 523b are not adjusted. Further, there may be instances when one lens 523 is adjusted but another lens 523 is not adjusted. Further, both lenses 523 can be adjusted at the same or different times. Whether a lens 523 is to be adjusted and the degree to which a lens 523 is adjusted can depends on the focus of each portion of each specimen to be imaged. Further, the stage 521 is not commanded to move until both cameras 524 have taken their images. Thus, if one camera 524 must first be focused then the other camera 524 will be until the stage 521 has been moved to a new location. According to one embodiment, the cameras 524 can be configured for synchronized focusing (i.e., both cameras focus at the same time) so that multiple lenses 523 are synchronized and simultaneously adjusted, as necessary, to adjust the focus of each specimen portion. Further, the cameras 524 can be synchronized so that after any lens 523 adjustments, the cameras 524 acquire images of portions of respective specimens at the same time.

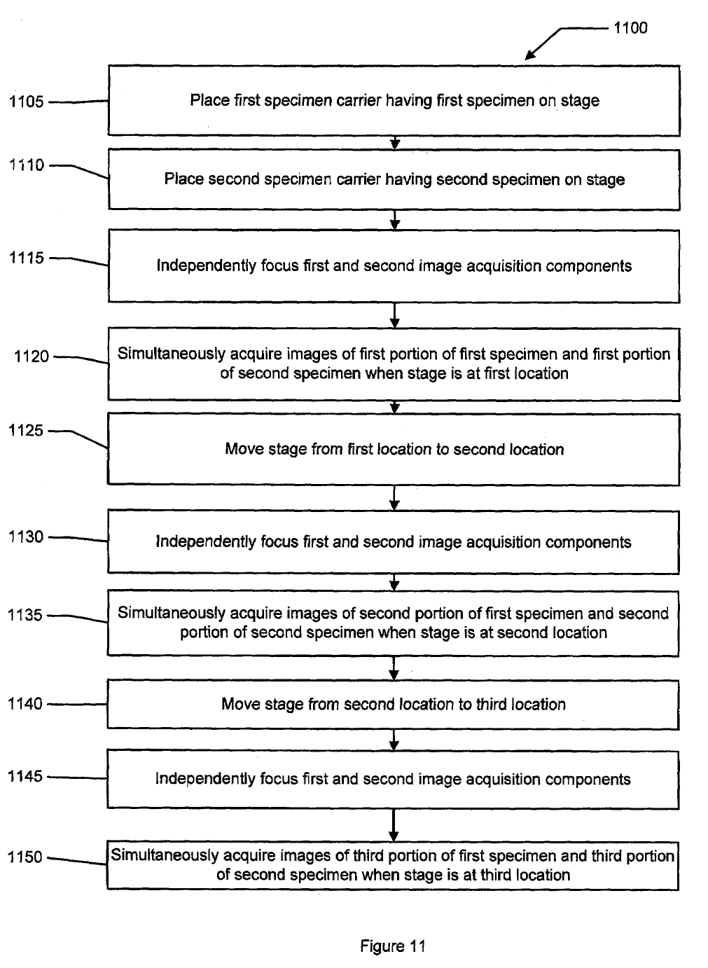

Referring to FIG. 11, a method 1100 of imaging multiple specimens simultaneously according to one embodiment includes placing a first specimen carrier or slide on the stage in step 1105. In step 1110, a second specimen carrier or slide is placed on the same stage. In step 1115, lenses can be independently adjusted as necessary in order to adjust the focus of the first portion of the first specimen and the first portion of the second specimen. In step 1120, after the lenses are adjusted, the images of the first and second specimens are acquired at the same time when the stage is at a first location.

In step 1125, after the images at the first location are acquired, the stage is moved from the first location to a second location. In step 1130, after the stage has moved and is allowed to settle, the lenses can be independently adjusted as necessary in order to adjust the focus of the next specimen portions to be imaged. In step 1135, images of the second portions of the first and second specimens are acquired at the same time while the stage is at the second location.

In step 1140, after the images are acquired at the second location, the stage is moved from the second location to the third location. The stage is allowed to settle in the third location, and in step 1145, the lenses can be independently adjusted as necessary in order to adjust the focus of the third portion of the first specimen and the third portion of the second specimen to be imaged. In step 1150, images of the third portions of the first and second specimens are acquired at the same time while the stage is at the third location. This process can be repeated for each specimen portion until the entire specimens are imaged.

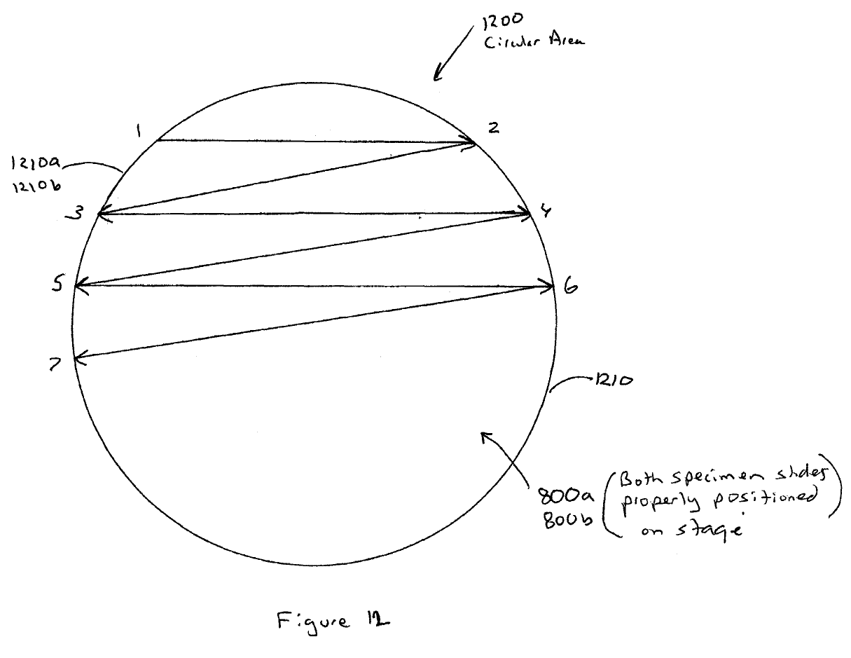

Referring to FIG. 12, each specimen 800a and 800b can be imaged using a prescribed raster pattern that covers a circular area 1200. The raster pattern begins from a known boundary 1210a of specimen 800a and a known boundary 1210b of specimen 800b. Each specimen 800 can be imaged by scanning across the specimen 800 beginning at point 1 and traversing back and forth between sections of the specimen boundary in the form of a raster pattern until the entire specimen is imaged. In FIG. 12, the boundaries of the first and second specimens 800a and 800b are shown as overlapping boundaries to illustrate that each specimen is properly positioned on the stage 521, although persons skilled in the art will appreciate that as shown in FIGS. 8 and 9, the slides 514 and specimens 800 are separated from each other.

A raster pattern that covers a circular area 1200 may be sufficient when imaging specimens 800a and 800b that are properly aligned on the stage 512 so that a first portion of the first specimen 800a that is imaged corresponds to the first portion of the second specimen 800b that is imaged, and so on for each portion of each specimen. However, there may be instances when a specimen slide is not properly aligned or positioned on the stage 512 with respect to its neighboring slide. This may cause a raster pattern that covers a circular area 1200 to miss part of the specimen that is improperly aligned or positioned on the stage 521.

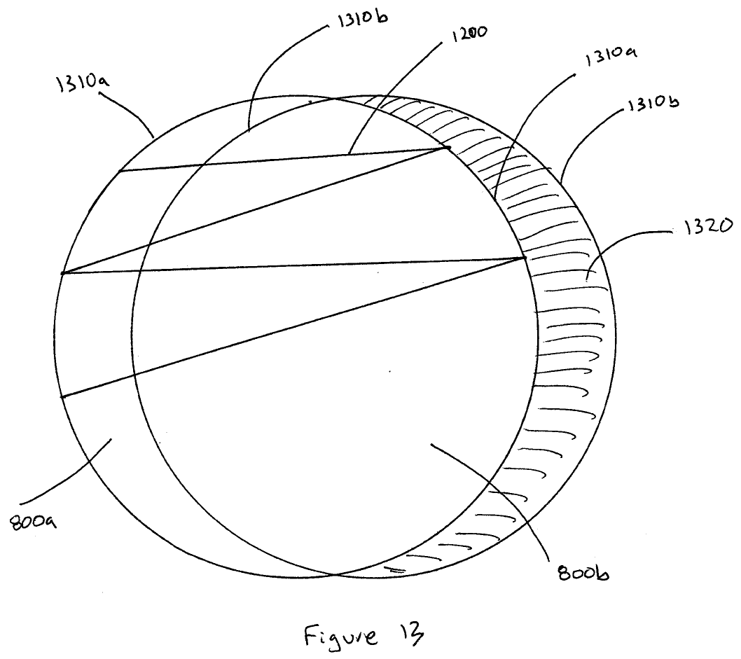

For example, FIG. 13 illustrates a boundary 1310a of a first specimen 800a placed on the stage 521 relative to a raster scan 1200 for that specimen 800a, and a boundary 1310b of a second specimen 800b on the stage 521. Again, the boundaries of the first and second specimens 800a and 800b are shown as partially overlapping boundaries to illustrate that one specimen is properly positioned on the stage 521 and can be properly imaged by a raster pattern that covers a circular area, whereas the other specimen is not properly positioned when in use, as shown in FIGS. 8 and 9, the slides 514 and specimens 800 are separated from each other.

As shown in FIG. 13, one of the specimen slides, such as the slide having specimen 800b, may not be properly positioned on the stage 521. As a result, when the stage 521 is moved to image the specimens 800a and 800b, the entire specimen 800a, which is properly positioned, is imaged in its entirety by a raster scan that covers a circular area, whereas a portion 1320 of the other specimen 800b, which is not properly positioned on the stage 521, is not imaged since it falls outside of the circular scanning area.

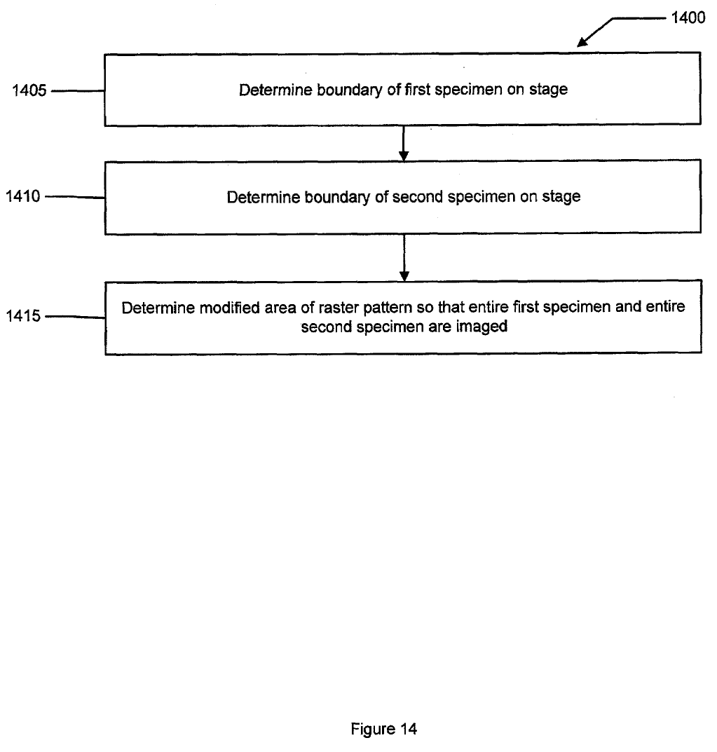

Referring to FIG. 14, to address any misalignments, a method 1400 for determining the shape or boundaries of a raster pattern to completely image multiple specimens according to one embodiment includes determining a boundary of a first specimen on the stage in step 1405, and determining a boundary of a second specimen on the stage in step 1410. In step 1415, a modified area of a raster pattern is determined so that all of the first and second specimens are imaged.

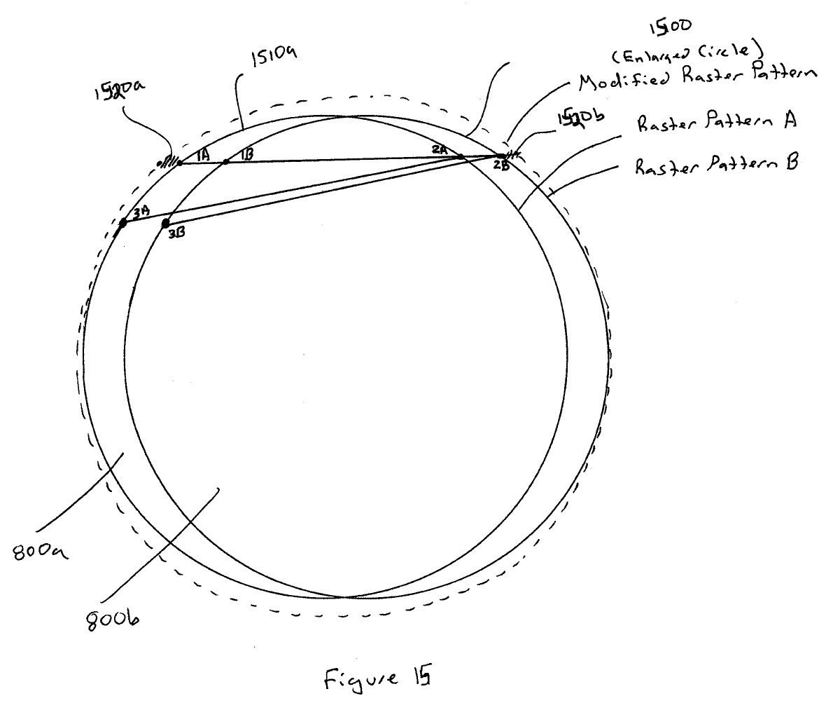

For example, referring to FIG. 15, one suitable modified raster pattern covers the area of an enlarged circular area 1500. A boundary 1510a of a first specimen 800a is imaged using a first raster pattern A (generally illustrated by 1A-2A-3A), and a boundary 1510b of a second specimen 800b is imaged using a second raster pattern B (generally illustrated by 1B-2B-2C). Each raster pattern individually would not generate a complete image of both the first and second specimens 800a and 800b as a result of gaps 1520a and 1520b. However, the scanning area can be modified so that the raster scan covers an enlarged circle 1500 that encompasses both the entire first specimen 800a and the entire second specimen 800b even if one specimen is misaligned.

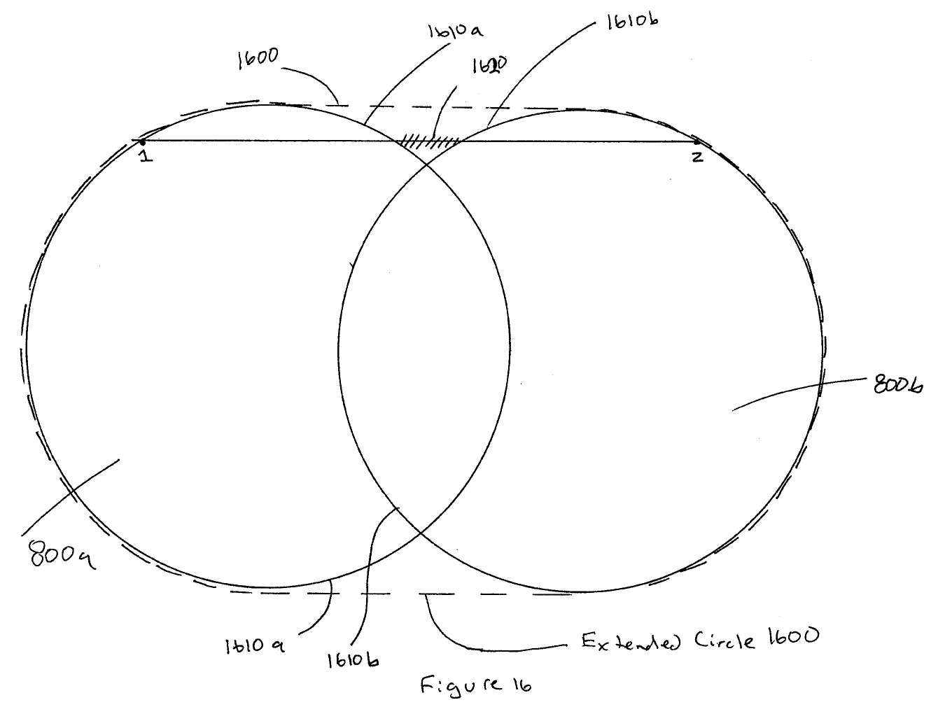

As a further example, referring to FIG. 16, a raster or scanning pattern can cover an extended circle 1600 that encompasses the boundary 1610a of the first specimen 800a and the boundary 1610b of the second specimen 800b. While there may be some small sections 1620 that result in imaging of blank sections that do not correspond to any specimen, a raster pattern that covers the extended circle 1600 ensures that the entire first specimen 800a and the entire second specimen 800b are imaged.

Embodiments provide a number of significant improvements over known imaging systems by imaging multiple specimen slides on a single stage and coordinating and synchronizing optical and mechanical components. As a result of embodiments, imaging capabilities are increased (e.g., multiplied by the number of slides imaged at one time) by using an imaging system that duplicates selected system components, but not all system components.

Persons skilled in the art will appreciate that various imaging system modifications can be made to implement embodiments. For example the camera, lens and focus controls and stage movements can be synchronized or timed depending on particular imaging system parameters. Thus, for example, if more time is required for a stage to settle after the stage is moved to a new location, the focus controls and camera can be delayed as necessary to accommodate longer settle times. Additionally, if the specimens are not consistent and vary specimen to specimen, additional time may be required to focus on different specimens. In this case, the system can be configured so that the cameras are delayed relative to an initial setting and are not activated to acquire images until the focus controls have sufficient time to obtain the best possible focus of each specimen portion.

Although particular embodiments have been shown and described, it should be understood that the above discussion is intended to be illustrative and not limiting, and that various changes and modifications may be made to the various embodiments without departing from the scope of the invention, which is limited only by the following claims.

What is claimed is:

1. A system for simultaneously imaging multiple biological specimen carriers, comprising:
a translatable stage configured for supporting a first specimen carrier having a first biological specimen and a second specimen carrier having a second biological specimen;
a first image acquisition component; and
a second image acquisition component, wherein the translatable stage and the first and second image acquisition components are arranged so that images of the first and second biological specimens can be substantially simultaneously acquired by the respective first and second image acquisition components.

2. The system of claim 1, the translatable stage and the first and second image acquisition components being arranged so that images of a first portion of the first specimen and a first portion of the second specimen can be substantially simultaneously acquired by respective first and second image acquisition components when the translatable stage is positioned at a first location.

3. The system of claim 2, the translatable stage being moveable from the first location to a second location so that images of a second portion of the first specimen and a second portion of the second specimen can be substantially simultaneously acquired by respective first and second image acquisition components when the translatable stage is positioned at the second location.

4. The system of claim 1, wherein the first and second image acquisition components are positioned above the respective first and second biological specimen carriers supported by the translatable stage.

5. The system of claim 1, the first and second specimen carriers being moveable at approximately the same time, by the approximately same amount, and in the approximately same direction as the translatable stage when the translatable stage is moved.

6. The system of claim 1, the respective first and second image acquisition components each comprising a camera and a lens positioned adjacent the camera.

7. The system of claim 6, wherein a lens of the first image acquisition component and a lens of the second acquisition component are independently adjustable.

8. The system of claim 7, wherein the lens of the first image acquisition component and the lens of the second acquisition component are independently and simultaneously adjustable to allow the first optical acquisition component to independently focus on the first specimen while the second optical acquisition component independently focuses on the second specimen.

9. The system of claim 1, further comprising a controller that controls movement of the translatable stage from a first location to a second location.

10. The system of claim 9, wherein the controller is configured to move the translatable stage from the first location to the second location after images are acquired of a first portion of the first specimen and of a first portion of the second specimen.

11. The system of claim 10, wherein the controller is configured to move the translatable stage from the second location to a third location after images of a second portion of the first specimen and a second portion of the second specimen are acquired.

12. The system of claim 1, the translatable stage supporting a third specimen carrier having a third biological specimen thereon, the system further comprising a third image acquisition component, wherein the translatable stage and the first, second and third image acquisition components are arranged so that images of the first, second and third biological specimens can be substantially simultaneously acquired by respective first, second and third image acquisition components.

13. A system for simultaneously imaging multiple biological specimens, comprising:
a translatable stage configured for supporting a first specimen carrier having a first biological specimen and a second specimen carrier having a second biological specimen;
a first image acquisition component;
a second image acquisition component; and
a controller for moving the translatable stage and controlling the first and second image acquisition components,
the translatable stage and the first and second image acquisition components being arranged and controlled so that
an image of a first portion of the first biological specimen and an image of a first portion of the second biological specimen may be substantially simultaneously acquired by respective first and second image acquisition components when the translatable stage is positioned at a first location, and
an image of a second portion of the first biological specimen and an image of a second portion of the second biological specimen may be substantially simultaneously acquired by the respective first and second image acquisition components when the translatable stage is positioned at a second location.

14. A method for simultaneously acquiring images of multiple biological specimens carried on respective specimen carriers, comprising:
placing a first specimen carrier having a first biological specimen and a second specimen carrier having a second biological specimen on a single, translatable stage;
substantially simultaneously acquiring images of the first and second biological specimens using respective first and second image acquisition components, while the translatable stage is positioned at a first location.

15. The method of claim 14, comprising
substantially simultaneously acquiring images of a first portion of the first biological specimen and a first portion of the second biological specimen when the translatable stage is positioned at the first location, and further comprising
moving the translatable stage from the first location to a second location, and
substantially simultaneously acquiring images of a second portion of the first biological specimen and a second portion of the second biological specimen is at the second location.

16. The method of claim 14, the respective first and second image acquisition components each comprising a camera and a lens positioned adjacent the camera, and wherein a lens of the first image acquisition component and a lens of the second acquisition component are independently adjustable.

17. The method of claim 16, wherein the lens of the first image acquisition component and the lens of the second acquisition component are independently and simultaneously adjustable to allow the first optical acquisition component to independently focus on the first specimen while the second optical acquisition component independently focuses on the second specimen.

18. A method for simultaneously imaging multiple biological specimens carried on respective specimen carriers, comprising:
placing a first specimen carrier having a first biological specimen and a second specimen carrier having a second biological specimen on a translatable stage;
substantially simultaneously acquiring images of a first portion of the first biological specimen with a first image acquisition component and a first portion of the second biological specimen with a second image acquisition component when the translatable stage is at a first location;
moving the translatable stage from the first location to a second location; and substantially simultaneously acquiring images of a second portion of the first biological specimen with the first image acquisition component and a second portion of the second biological specimen with the second image acquisition component when the translatable stage is at the second location; and
independently focusing the first and second image acquisition components prior to acquiring images of the respective second portions of the first and second biological specimens.
